(19) United States
(12) Patent Application Publication
(10) Pub. No.: US 2025/0140030 A1
(43) Pub. Date: May 1, 2025

(54) VEHICLE ACCIDENT DETECTION AND AUTOMATIC REPORTING SYSTEM THAT ALLOWS AUTOMATIC GENERATION OF VEHICLE ACCIDENT REPORTS

(71) Applicant: Myren Inc., Siheung-si (KR)

(72) Inventor: Eun Hong Choi, Gwangmyeong-si (KR)

(73) Assignee: Myren Inc., Siheung-si (KR)

(21) Appl. No.: 18/495,260

(22) Filed: Oct. 26, 2023

(51) Int. Cl. G07C 5/00; G07C 5/02

(52) U.S. Cl. CPC G07C 5/008; G07C 5/02

(57) ABSTRACT

A vehicle accident detection and automatic reporting system includes: a vehicle terminal mounted on a vehicle and acquiring driving information of the vehicle; and a user terminal owned by a user riding in the vehicle, wherein the user terminal includes: a sensor module for sensing movement information of the vehicle; a communication unit for communicating with the vehicle terminal and receiving driving information of the vehicle; and a control unit for determining whether an accident occurs in the vehicle by using the driving information and the movement information of the vehicle.

### BACKGROUND OF THE INVENTION

### 1. Field of the Invention

The present invention relates to a vehicle accident detection and automatic reporting system, and more particularly, provides a vehicle accident detection and automatic reporting system capable of automatically generating an accident report and transmitting the generated accident report to emergency rescue organizations.

### 2. Description of the Related Art

In order to deal with a traffic accident in the related art, a driver may directly contacts the rescue team or the police, or another person, such as an opposite driver or an eyewitness, may notify the rescue team or the police of the accident situation.

However, in order for the driver to directly contact emergency contact networks for the rescue teams or police, or insurance companies, the driver may be required to take various actions in accordance with the traffic accident safety rules, and this may result in a delay in the time for the accident notification.

Particularly, when a driver and passengers lose consciousness due to a vehicle accident in a lonesome situation such as at late night, early morning or on a remote road, reports are delayed due to few witnesses, thereby causing catastrophic events leading to death.

Accordingly, there are needs for a real-time emergency rescue system platform for automatically report when the driver and passengers fail to report by themselves in a situation where there is no witness upon the vehicle accident.

### SUMMARY OF THE INVENTION

The present invention provides a vehicle accident detection and automatic reporting system in which a vehicle accident is notified from a user terminal to a vehicle accident notification server upon occurrence of accident, and the vehicle accident notification server notifies the accident to an accident response organization, so that a response to the accident may be rapidly performed.

In addition, the present invention provides a vehicle accident detection and automatic reporting system, in which, when a transmission-standby status maintaining time, which is preset for waiting for transmitting data, has elapsed upon occurrence of an accident, the accident is automatically notified to the vehicle accident notification server, so as to respond to the accident.

In addition, the present invention provides a vehicle accident detection and automatic reporting system capable of automatically generating a vehicle accident report upon a vehicle accident and transmitting the generated accident report to emergency rescue organizations.

The vehicle accident detection and automatic reporting system according to the embodiment of the present invention includes: a vehicle terminal mounted on a vehicle and acquiring driving information of the vehicle; and a user terminal owned by a user riding in the vehicle, wherein the user terminal includes: a sensor module for sensing movement information of the vehicle; a communication unit for communicating with the vehicle terminal and receiving driving information of the vehicle; and a control unit for determining whether an accident occurs in the vehicle by using the driving information and the movement information of the vehicle.

In addition, the control unit may include a report generation unit for generating an accident report by using the driving information and the movement information of the vehicle when determining that an accident occurs in the vehicle.

In addition, the accident report may include driver information, vehicle identification information, accident type information, accident location information, accident time information, weather information, vehicle body movement information, and satellite photo information on an accident site.

In addition, the vehicle body movement information may include yaw, roll and acceleration information of a vehicle body.

In addition, the system according to the present invention may include a vehicle accident notification server for receiving the accident report from the communication unit and transmitting the accident report to an accident response organization.

In addition, the control unit may display an accident confirmation message on a display of the user terminal for a preset time when determining that an accident occurs in the vehicle, and the report generation unit may generate the accident report when the user checks the accident confirmation message or the preset time elapses.

According to the present invention, when a vehicle accident occurs, the fact that the accident has occurred is notified from the user terminal to the vehicle accident notification server, and the vehicle accident notification server notifies the accident to an accident response organization, so that a response to the accident can be rapidly performed.

In addition, according to the present invention, when a transmission-standby status maintaining time, which is preset for waiting for transmitting data, has elapsed upon occurrence of an accident, the accident is automatically notified to a vehicle accident notification server, so that a response to the accident can be performed.

In addition, according to the present invention, a vehicle accident report is automatically generated upon a vehicle accident and the generated accident report is transmitted to emergency rescue organizations, so that the emergency rescue organizations can quickly identify a vehicle accident type, a vehicle accident location, accident vehicle information, driver information, and the like.

### BRIEF DESCRIPTION OF THE DRAWINGS

FIG. 1 is a diagram showing a vehicle accident detection and automatic reporting system according to the embodiment of the present invention.

FIG. 2 is a diagram showing the detailed configuration of the user terminal in FIG. 1.

FIG. 3 is a diagram showing the detailed configuration of the control unit according to the embodiment of the present invention.

FIG. 4 is a diagram showing information included in an accident report according to one embodiment of the present invention.

FIG. 5 is a diagram showing a vehicle accident notification server according to the embodiment of the present invention.

FIG. 6 is a diagram showing the detailed configuration of a central processing unit according to the embodiment of the present invention.

### DETAILED DESCRIPTION OF THE INVENTION

Hereinafter, exemplary embodiments of the present invention will be described in detail with reference to the accompanying drawings. However, the technical idea of the present invention is not limited to the exemplary embodiments described herein and may be embodied in other forms. Further, the embodiments are provided to enable contents disclosed herein to be thorough and complete and provided to enable those skilled in the art to fully understand the idea of the present invention.

In the specification herein, when one component is mentioned as being on other component, it signifies that the one component may be placed directly on the other component or a third component may be interposed therebetween. In addition, in drawings, thicknesses of layers and areas may be exaggerated to effectively describe the technology of the present invention.

In addition, although terms such as first, second and third are used to describe various components in various embodiments of the present specification, the components will not be limited by the terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it will be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, in the following description of the embodiments of the present invention, the detailed description of known functions and configurations incorporated herein will be omitted when it possibly makes the subject matter of the present invention unclear unnecessarily.

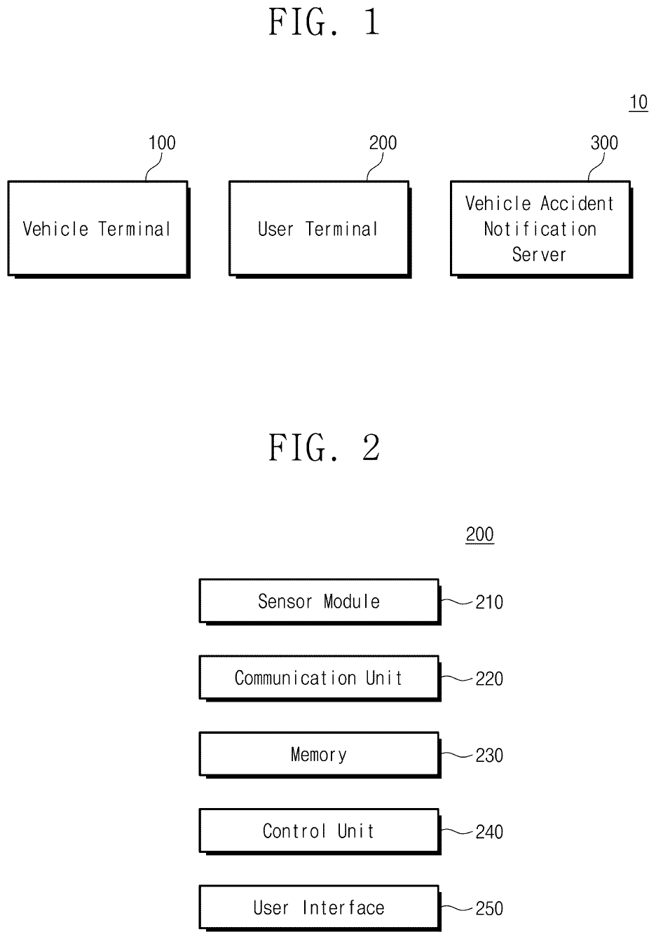

FIG. 1 is a diagram showing a vehicle accident detection and automatic reporting system according to the embodiment of the present invention. FIG. 2 is a diagram showing the detailed configuration of the user terminal in FIG. 1.

Referring to FIGS. 1 and 2, a vehicle accident detection and automatic reporting system 10 uses information measured from a vehicle terminal 100 and a user terminal 200 when an accident occurs in a vehicle on which a user gets to determine whether a vehicle accident has occurred via the user terminal 200, and transmits the vehicle accident occurrence to a vehicle accident notification server 300. The vehicle accident notification server 300 provides a vehicle accident notification service to transmit the vehicle accident occurrence to a pre-set accident response organization such as an insurance company, an emergency rescue organization such as 911, a vehicle towing company, and other emergency contacts set by the user, so as to enable handling in response to the accident.

The vehicle accident detection and automatic reporting system 10 includes the vehicle terminal 100, the user terminal 200, and the vehicle accident notification server 300.

The vehicle terminal 100 is installed on the vehicle and collects driving information of the vehicle. The vehicle terminal 100 collects electrical/electronic operating states of the vehicle. Specifically, the vehicle terminal 100 collects the vehicle's driving speed, driving location information, driving distance information, RPM, brake signal information, accelerator pedal signal information, vehicle internal temperature information, and vehicle external temperature information. The vehicle terminal 100 may wirelessly communicate with the user terminal 200. According to the embodiment, the vehicle terminal 100 may communicate with the user terminal 200 through Bluetooth communication. According to the embodiment, the vehicle terminal 100 may use on-board diagnostics (OBD).

The user terminal 200 refers to a terminal owned by a user riding in the vehicle, and is positioned inside the vehicle while the vehicle is driving. The user terminal 200 may be carried by the user in the vehicle or mounted inside the vehicle. The user terminal 200 may include various types of terminals or electronic equipment, such as a mobile phone, a smart phone, and a tablet PC, capable of data communication via wired or wireless. The user terminal 200 may be connected to the vehicle terminal 100 and the vehicle accident notification server 300 through wireless communication.

The user terminal 200 includes a sensor module 210, a communication unit 220, a memory 230, a control unit 240, and a user interface 250.

The sensor module 210 detects movement information of the vehicle. The sensor module 210 may include a shock sensor module for detecting a shock applied to the vehicle. For example, the shock sensor module may be provided as an acceleration sensor. The acceleration sensor may be provided as a 3-axis acceleration sensor, and may detect an up-down impulse, a front-rear impulse, and a left-right impulse. The acceleration sensor may be controlled such that sensitivity of a sensor value is adjusted according to the speed of the vehicle. The acceleration sensor may be adjusted to have the sensitivity of the front-rear impulse or the left-right impulse greater than the sensitivity of the up-down impulse, so as to improve the discrimination of determination on the accident. For example, when a vehicle crosses a speed bump, the up-down impulse of the vehicle is greater than the left-right impulse or front-rear impulse. Accordingly, in the case of a slow mode, the sensitivity of the up-down impulse may be controlled to be set lower than the left-right impulse or the front-rear impulse.

In addition, the shock sensor module may include an acceleration sensor and a gyro sensor. Accordingly, the accuracy of detecting a state such as a speed change of the vehicle during driving, sudden braking of the vehicle, or sudden rotation or overturn of the vehicle due to a shock may be improved. For example, the type of overturn may be determined using changes in longitudinal speed and changes in lateral speed of the vehicle. In order to more accurately determine the type of overturn, at least one of changes in size of yaw and roll detected by the gyro sensor and vertical acceleration detected by the acceleration sensor may be used for the determination. The type of overturn may be determined a ramp mode when the vehicle turns while either a right or left side of the vehicle is driving on a ramp; a ditch mode when the vehicle enters and turns on a downward ramp such as a dike; a bump mode when the vehicle turns in the lateral direction on a stepped part such as a curb stone on the road; and as a sand mode when the vehicle enters a road surface, such as a sandy road, having a large friction coefficient, and turns due to hindrance in the lateral direction, and may be determined as an auxiliary mode when it is not determined by any type among the above types of overturn determinations.

In addition, the sensor module 210 may further include a position sensor module. The position sensor module detects changes in position of the vehicle. In addition, the speed of the vehicle may be calculated through the changes in position of the vehicle detected by the position sensor module. The position sensor module may be a GPS sensor.

In addition, the sensor module 210 may further include a gravity sensor and a geomagnetic sensor. The gravity sensor may detect a vertical position of the user terminal 200, and the geomagnetic sensor may detect azimuth.

The memory 230 may store various data such as a client program for using the vehicle accident notification service, data generated for operating the client program, data received from the vehicle accident notification server 300, and a detected value of sensor module 110. In addition, the memory 130 may store pattern information. The pattern information serves for the basis of determining whether the accident has occurred in the vehicle and is provided in the form of a pattern of data. In addition, the pattern information may be updated through the data transmitted from the vehicle accident notification server 300. The pattern information includes impulse pattern information. The impulse pattern information is provided in an impulse pattern form when the vehicle is in a normal state or an abnormal state. The impulse pattern information may include the pattern forms of the up-down impulse, the front-rear impulse, and the left-right impulse. In addition, the impulse pattern information may include an inclination pattern form of a vehicle body in response to the detection value of the gyro sensor. In addition, the impulse pattern information may be provided in the form in which impulse pattern forms are assigned according to the speeds of the vehicle, respectively. In addition, the pattern information may include sound pattern information. The sound pattern information is provided in a sound pattern form when the vehicle is in a normal state or an abnormal state. In addition, the sound pattern information may be provided in the form in which sound pattern forms are assigned according to the speeds of the vehicle, respectively. The memory 230 collectively refers to a non-volatile storage device configured to maintain stored information even when power is not supplied.

The control unit 240 may execute the client program stored in the memory 230, and apply data received from the vehicle terminal 100, data detected by the sensor module 210, data received from the vehicle accident notification server 300, and data stored in the memory 230 to the program. The control unit 240 automatically executes the client program when the vehicle speed is a reference speed or higher. According to the embodiment, the control unit 240 automatically executes the client program when the vehicle speed is 15 km/h or higher. When the client program is executed, an alarm indicating, which a real-time accident detection mode is in operation, is displayed on the display of the user terminal 200. The client program performs a series of processes from accident detection to accident reporting.

The control unit 240 uses a previously learned AI deep learning algorithm to determine whether an accident has occurred in the vehicle through the data received from the vehicle terminal 100 and the data detected by the sensor module 210, and transmits accident data to the vehicle accident notification server 300 through the communication unit 230 when determining that the accident has occurred.

The control unit 240 primarily determines whether the accident has occurred in the vehicle by using the data received from the vehicle terminal 100, and secondarily determines whether the accident has occurred in the vehicle by using the data received from the sensor module 210. The control unit 240 may sequentially perform the primary and secondary determinations on whether the vehicle accident has occurred. The control unit 240 may control the client program to monitor the status and occurrence of the vehicle while being in a background executed state, so that accident data may be transmitted to the vehicle accident notification server 300 when the accident occurrence is detected.

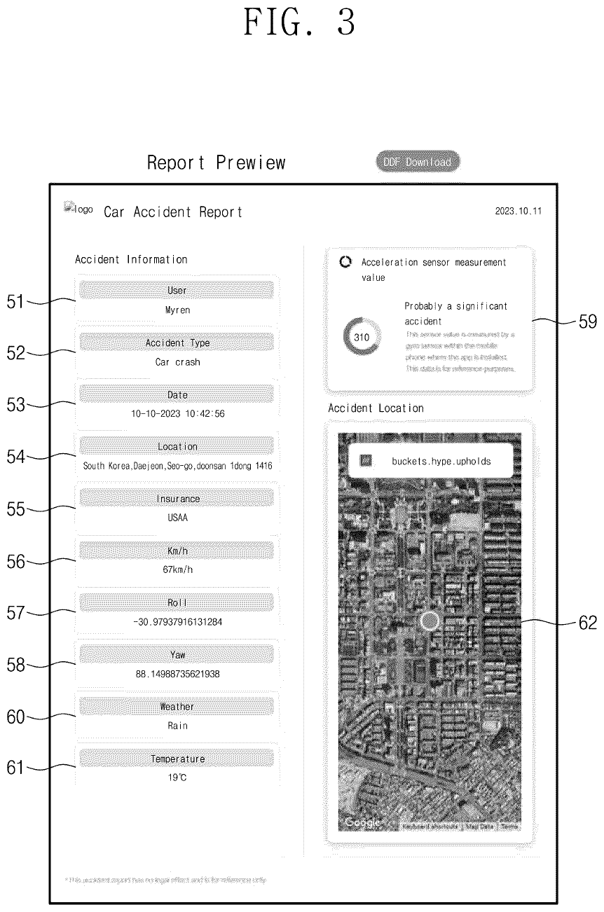

FIG. 3 is a diagram showing the detailed configuration of the control unit according to the embodiment of the present invention.

Referring to FIG. 3, the control unit 240 includes a recording unit 241, an accident detection unit 242, a report generation unit 243, and an accident notification unit 244.

The recording unit 241 records surrounding sounds. In other words, the recording unit 241 may record sound generated by the vehicle while the vehicle is driving through a microphone provided in the user terminal 200 or connected to the user terminal 200, and may record crashing sounds and glass breakage sounds generated when the vehicle collides with another object in the event of an accident.

The accident detection unit 242 compares values measured by the vehicle terminal 100 and the sensor module 210 with the pattern information, thereby detecting whether the accident has occurred by using a previously learned AI deep learning algorithm. Specifically, the accident detection unit 242 may determine that the accident has occurred when a matching degree corresponds to a preset value or higher by comparing the values measured by the vehicle terminal 100 and the sensor module 210 with the impulse pattern information. When the impulse pattern information is assigned according to the speeds of the vehicle, respectively, the accident detection unit 242 may apply the speed of the vehicle. In addition, the accident detection unit 242 may additionally apply the degree of matching to the accident determination by comparing the sound stored through the recording unit 241 with the sound pattern information.

When the accident detection unit 242 determines that the accident has occurred, the report generation unit 243 generates an accident report by using the vehicle's driving information generated by the vehicle terminal 100 and the vehicle's movement information generated by the sensor module 210.

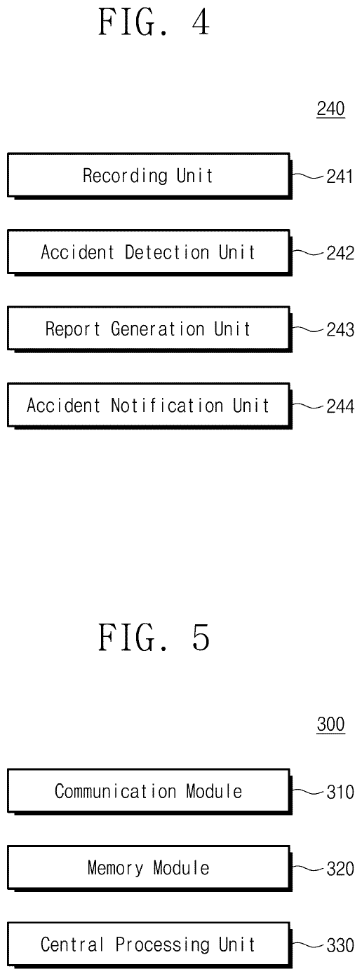

FIG. 4 is a diagram showing information included in an accident report according to one embodiment of the present invention.

Referring to FIG. 4, the accident report 50 includes driver information 51, accident type information 52, accident time information 53, accident location information 54, vehicle insurance information 55, vehicle body movement information 56, 57, 58 and 59, weather information 60, temperature information 61, and satellite photo information 62 on an accident site. In addition, although not shown in the drawing, the accident report 50 may further include vehicle identification information.

The driver information 51 refers to user information stored in the user terminal 200, and may include name, age, gender, height, weight, blood type, driver's license information, and driving history information.

The accident type information 52 refers to an accident type calculated using the information measured from the vehicle terminal 100 and the sensor module 210, and topographical information of the vehicle's driving location. The accident type information 52 is indicated by, for example, whether the vehicle accident is a collision between vehicles, whether the vehicle accident is a collision between a vehicle and a human, whether the vehicle accident is a collision between a vehicle and a surrounding facility, or whether the vehicle accident is a vehicle rollover.

The accident time information 53 refers to information on the time when a vehicle impact is detected, and includes information on year/month/day/time.

The accident location information 54 refers to information on a geographical location in which the vehicle accident has occurred, and includes GPS information and address information.

The vehicle body movement information 56, 57, 58 and 59 refers to information on vehicle body movements immediately before and immediately after the vehicle accident has occurred, and includes information on speed 56, roll 57, yaw 58 and acceleration 59 of the vehicle body. The vehicle body movement information 56, 57, 58 and 59 may be calculated by inputting the information measured by the vehicle terminal 100 and the sensor module 210 into a previously stored algorithm. The vehicle body movement information may separately display yaw, roll and acceleration and may be displayed numerically or graphically.

The weather information 60 refers to weather information in an area in which the vehicle accident has occurred.

The temperature information 61 refers to a temperature in the area in which the vehicle accident has occurred.

The satellite photo information 62 on the accident site is provided by indicating the location of the vehicle on a satellite photo of the location in which the vehicle accident has occurred.

The vehicle identification information includes information on the vehicle, such as vehicle model, model year and vehicle number.

Upon determination of accident in the vehicle, the report generation unit 243 generates the accident report 50 when an accident confirmation message is displayed on the display of the user terminal 200 for a preset time and the user touches or confirms the message or a preset time elapses. The preset time may be set to 20 seconds to 40 seconds. In addition, the preset time may be provided to be adjusted by the user after executing the client program.

When the user touches or checks the message displayed on the display of the user terminal 200 or a preset time elapses, the accident notification unit 244 transmits the accident data and the accident report 50 to the vehicle accident notification server 300.

Referring back to FIG. 2, the user interface 250 includes a display, and may display a status of the user terminal 200, a status of the client program and the like. In addition, the user interface 250 may include a touch panel, a keyboard and the like, so that the user may directly input data for operating the user terminal 200.

The vehicle accident notification server 300 is connected to the user terminal 200 and servers of the accident response organizations through a network, and has a connection structure that allows nodes to exchange information to each other.

FIG. 5 is a diagram showing a vehicle accident notification server according to the embodiment of the present invention.

Referring to FIG. 5, the vehicle accident notification server 300 includes a communication module 310, a memory module 320, and a central processing unit 330.

The communication module 310 may be provided to enable wired and wireless data communication through the network, and transmit and receive data with the user terminal 200. The communication module 310 may receive the accident data and the accident report from the user terminal 200, and transmit the accident notification data to a server, terminal and the like of a related organization. The accident notification data and the accident report refer to data that notifies the occurrence of the accident to insurance companies, emergency rescue agencies such as 911, vehicle towing companies, and other emergency contacts set by the user.

The memory module 320 may store received data, a program for providing a vehicle accident notification service, processing data generated by processing the received data, a program for performing an accident simulation and other various data. The memory module 320 collectively refers to a non-volatile storage device configured to maintain stored information even when power is not supplied.

The central processing unit 330 executes the program stored in the memory module 320, and applies the saved data to the program. The central processing unit 330 may be understood as a processor that can control the communication module 310 and the memory module 320 and can read and process data received through the communication module 310 or stored in the memory module 320 according to a predetermined program.

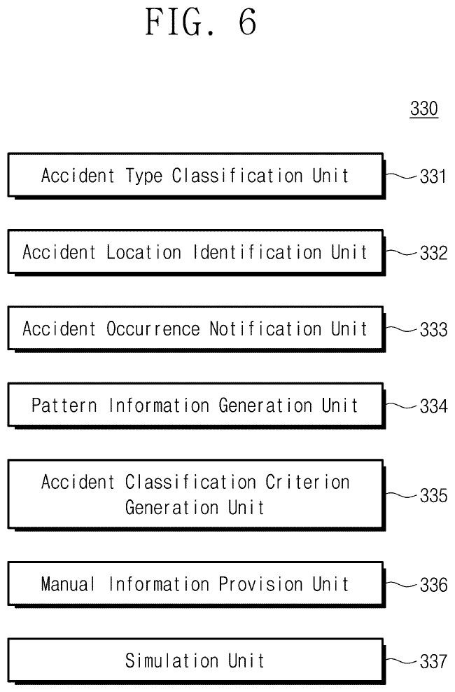

FIG. 6 is a diagram showing the detailed configuration of a central processing unit according to the embodiment of the present invention.

Referring to FIG. 6, the central processing unit 330 includes an accident type classification unit 331, an accident location identification unit 332, an accident occurrence notification unit 333, a pattern information generation unit 334, an accident classification criterion generation unit 335, a manual information provision unit 336 and a simulation unit 337.

The accident type classification unit 331 classifies an accident type of the vehicle based on received accident data and preset accident type classification criteria. For example, the accident type classification unit 331 may automatically classify the accident type on whether the current vehicle accident is caused by signal violation, intersection violation, center line violation, sudden lane change, obstacle, parking terrorism or the like, or a simple minor collision, or whether the accident is caused by colliding with a two-wheeled vehicle or a person. In addition, the accident type classification unit 331 may classify the accident type into sudden acceleration, sudden stop, collision, overturn, complete deviation, and the like. This may be applied when the vehicle in which the user rides is mobility or personal mobility. The mobility may be applied to cars and taxis, and The personal mobility may be applied to electric kickboards and bicycles. In addition, the accident type classification unit 331 may classify the accident type into falling, dropping, walking deviation, and the like. This may be applied when the vehicle in which the user rides is green mobility or when the user is walking. The green mobility may include electric wheelchairs and wheelchairs, and the pedestrian may include school staff and students.

The accident occurrence position determination unit 332 functions to identify the current accident occurrence position based on the received accident data. In other words, the accident occurrence position determination unit 332 may identify the position of the accident through the current vehicle position detected by the position sensor at the time of transmitting the accident data included in the accident data.

The accident occurrence notification unit 333 may transmit the accident notification data to a preset accident response agency. In other words, the accident occurrence notification unit 333 is provided to have URL addresses, phone numbers and the like for transmitting accident notification data to each of insurance companies, PM companies, emergency rescue organizations such as 911, vehicle towing companies, school control centers, living lab centers, emergency organizations, family/acquaintances, and other emergency contact number set by the user, so that the accident notification data may be transmitted to the organizations.

The pattern information generation unit 334 may generate a pattern between accident data and an actual occurrence of an accident. In other words, the pattern information generation unit 334 defines the accident data as an input factor and defines the output of the accident detection unit 242 as an output factor, and then derives a correlation between the input factor and the output factor, thereby generating pattern information. The pattern information generation unit 334 may be implemented through deep learning based on deep neural networks, so as to derive the correlation between the input factor and the output factor. In addition, the pattern information generation unit 334 may update existing pattern information through new pattern information. When the pattern information is updated, the pattern information generation unit 334 transmits the updated pattern information to the user terminal 200, so that the accident detection unit 242 may detect whether the accident has occurred by using the updated pattern information.

The accident occurrence classification criterion generation unit 335 may generate accident type classification criteria. In other words, the accident occurrence classification criterion generation unit 335 defines the accident data as an input factor and defines the output of the accident type classification unit 331 as an output factor, and then derives a correlation between the input factor and the output factor, thereby generating the accident type classification criteria. In addition, the accident occurrence classification criterion generation unit 335 may update existing accident type classification criteria through new accident type classification criteria. The accident occurrence classification criterion generation unit 335 may be implemented through deep learning based on deep neural networks, so as to derive the correlation between the input factor and the output factor.

The manual information provision unit 336 may transmit an accident response manual to the user terminal 200. The response manual may be provided in the form of text information displayed on the user terminal 200 or voice information output through a speaker provided in the user terminal 200. The response manual may include notification information about a situation in which the accident notification data is notified to the preset organizations, notification information for guiding the user to photograph scenes of the accident for post-processing of the accident, and information for guiding the user to move to a safe place and await. When the accident data is automatically transmitted to subject the time for maintaining the transmission-standby state from the accident notification unit 224 of the user terminal 200, the manual information provision unit 336 may transmit a consciousness confirmation message for confirming whether the user is conscious to the user terminal 200. In addition, when a reply according to the consciousness confirmation message is not received within a preset period of time, the state that the user lost consciousness may be transferred to the accident notification unit 244, and the accident notification unit 224 may additionally transmit an emergency message for informing the possibility of emergency to the preset organizations.

The simulation unit 337 may perform a simulation using the accident data received from the user terminal 200. For example, the simulation unit 337 may be provided to perform the simulation based on mathematical dynamic models (MADYMO) program. The simulation unit 337 may function to analyze causes of the vehicle accident and determine a causal relationship of the injury through a three-dimensional simulation using the received accident data. Thereafter, the simulation results may be provided to an accident handling organization so as to accurately determine the situation. The simulation unit 337 may be provided to perform a simulation for each of different simulation conditions. In other words, the simulation unit 337 includes various data necessary for analyzing occupant behaviors of the vehicle, such as data on a vehicle type and a vehicle structure thereby, data on a dummy used in an experiment, data on safety parts, and data on vehicle motion properties upon collision. Preferably, the test conditions for each vehicle type may be provided in a database state, so that the simulation may be performed quickly for various vehicle types.

The vehicle accident notification system 10 according to one embodiment of the present invention is provided such that, upon accident, the accident is detected through the vehicle terminal 100 and the user terminal 200, the accident occurrence is notified to the vehicle accident notification server 300, and then the accident occurrence is notified to the organizations and the like for handling the accident. Accordingly, the accident occurrence can be more quickly notified to the organizations and the accident can be handled, compared when the user personally notifies each of the organizations of the accident occurrence for handling the accident. Particularly, in consideration of the driver embarrassed upon occurrence of an accident, the vehicle accident notification system according to one embodiment of the present invention can facilitate the remarkably quick accident notification and accident handling.

In addition, according to the vehicle accident notification system 10 of the embodiment of the present invention, the accident occurrence is notified to the organizations for responding to the accident even when the driver loses consciousness due to the accident, so that the accident occurrence can be notified and the driver can be rescued quickly even when the driver loses consciousness due to the accident.

In addition, the vehicle accident notification system 10 according to one embodiment of the present invention may provide a safety integrated data management-based service and a data analysis and linkage service based on AI deep learning. The safety integrated data management-based service may perform a safety data linkage collection system, an integrated big data establishment, and an infrastructure system operation and management. The data analysis and linkage system may provide an AI-based risk zone analysis system, a GIS safety analysis system, and data services linkage/sharing with related organizations.

Although the present invention has been described in detail with reference to the exemplary embodiments, the present invention is not limited to the specific embodiments and shall be interpreted by the following claims. In addition, it will be apparent that a person having ordinary skill in the art may carry out various deformations and modifications for the embodiments described as above within the scope without departing from the present invention.

What is claimed is:

1. A vehicle accident detection and automatic reporting system comprising:
a vehicle terminal mounted on a vehicle and acquiring driving information of the vehicle; and
a user terminal owned by a user riding in the vehicle, wherein
the user terminal includes:
a sensor module for sensing movement information of the vehicle;
a communication unit for communicating with the vehicle terminal and receiving driving information of the vehicle; and
a control unit for determining whether an accident occurs in the vehicle by using the driving information and the movement information of the vehicle.

2. The vehicle accident detection and automatic reporting system of claim 1, wherein the control unit includes a report generation unit for generating an accident report by using the driving information and the movement information of the vehicle upon determination of occurrence of the accident in the vehicle.

3. The vehicle accident detection and automatic reporting system of claim 2, wherein the accident report includes driver information, vehicle identification information, accident type information, accident location information, time information, weather information, vehicle body movement information, and satellite photo information on an accident site.

4. The vehicle accident detection and automatic reporting system of claim 3, wherein the vehicle body movement information includes yaw, roll and acceleration information of a vehicle body.

5. The vehicle accident detection and automatic reporting system of claim 2, further comprising:
a vehicle accident notification server for receiving the accident report from the communication unit and transmitting the accident report to an accident response organization.

6. The vehicle accident detection and automatic reporting system of claim 2, wherein
the control unit displays an accident confirmation message on a display of the user terminal for a preset time upon determination of occurrence of the accident in the vehicle, and the report generation unit generates the accident report when the user checks the accident confirmation message or the preset time elapses.
